(19) United States
(12) Patent Application Publication
(10) Pub. No.: US 2018/0181257 A1
(43) Pub. Date: Jun. 28, 2018

(54) METHOD FOR USER INTERFACE OF FOLDABLE DISPLAY APPARATUS

(71) Applicant: INDUSTRIAL TECHNOLOGY RESEARCH INSTITUTE, Hsinchu (TW)

(72) Inventors: Sheng-Po WANG, Taoyuan City (TW); Heng-Yin CHEN, Zhubei City (TW)

(73) Assignee: INDUSTRIAL TECHNOLOGY RESEARCH INSTITUTE, Hsinchu (TW)

(21) Appl. No.: 15/391,359

(22) Filed: Dec. 27, 2016

(51) Int. Cl. G06F 3/041; G06F 1/16; G06F 3/0488

(52) U.S. Cl. CPC G06F 3/0418; G06F 3/04883; G06F 1/1643; G06F 1/1652

(57) ABSTRACT

A method for a user interface of a foldable display apparatus. Detect a device status of the foldable display apparatus, and read at least one touch point report data. Determine a region, where a touch event occurs, according to the device status and the touch point report data. Trigger the user interface according to the device status and the touch point report data.

### TECHNICAL FIELD

The disclosure relates to a method for a user interface of a foldable display apparatus.

### BACKGROUND

The advance of technology has made that the performance of touch panels is enhanced gradually, and the cost is no longer high. Moreover, since touch input is intuitive, simple, and various, touch panels as human-machine interfaces have be universalized in the market of consumer electronics. For example, touch panels are used in mobile phones, tablet computers, laptop computers or user interfaces of a variety of household electric appliances.

Recently, flexible or foldable display panels have been created in order to provide electronic products that are more user-friendly and beautiful. However, this has brought into that user interfaces or control systems nowadays do not have a great idea to prevent display panels in a variety of folding patterns from the occurrence of incorrect operations.

### SUMMARY

According to one or more embodiments of the present disclosure, a user interface method for a foldable display apparatus includes detecting a device status of the foldable display apparatus and reading at least one touch point report data; determining a region, where a touch event occurs, according to the device status and the touch point report data; and linking to and triggering the user interface according to the device status and the touch point report data.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1A is a schematic view of a display apparatus that is flattened according to an embodiment of the present disclosure;

FIG. 1B is a schematic view of a display apparatus fully outward-folded according to an embodiment of the present disclosure;

FIG. 1C is a schematic view of a display apparatus partially outward-folded according to an embodiment of the present disclosure;

FIG. 1D is a schematic view of a display apparatus fully inward-folded according to an embodiment of the present disclosure;

FIG. 1E is a schematic view of a display apparatus partially inward-folded according to an embodiment of the present disclosure;

FIG. 2A is a schematic view of a display apparatus fully outward-folded according to another embodiment of the present disclosure;

FIG. 2B is a schematic view of a display apparatus partially outward-folded according to another embodiment of the present disclosure;

FIG. 2C is a schematic view of a display apparatus fully inward-folded according to another embodiment of the present disclosure;

FIG. 2D is a schematic view of a display apparatus partially inward-folded according to another embodiment of the present disclosure;

FIG. 3 is a schematic view of an incorrect operation occurring on the display apparatus that is fully outward-folded according to an embodiment of the present disclosure;

FIG. 4 is a flowchart of a method for a user interface of a foldable display apparatus according to an embodiment of the present disclosure;

FIG. 5A is a schematic view of a display apparatus according to yet another embodiment of the present disclosure;

FIG. 5B is a schematic view of a display apparatus according to yet another embodiment of the present disclosure;

FIG. 6A is flowchart of determining a touch point report according to an embodiment of the present disclosure;

FIG. 6B is flowchart of determining a touch point report according to an embodiment of the present disclosure;

FIG. 6C is flowchart of determining a touch point report according to an embodiment of the present disclosure;

FIG. 7 is a detailed flowchart of a method for a user interface of a foldable display apparatus according to an embodiment of the present disclosure;

FIG. 8 is a detailed flowchart of a method for a user interface of a foldable display apparatus according to another embodiment of the present disclosure;

FIG. 9 is a detailed flowchart of a method for a user interface of a foldable display apparatus according to yet another embodiment of the present disclosure;

FIG. 10A is a schematic view of a foldable display apparatus that is curved as a circle according to an embodiment of the present disclosure; and

FIG. 10B is a detailed flowchart of a method for a user interface of a foldable display apparatus according to yet another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

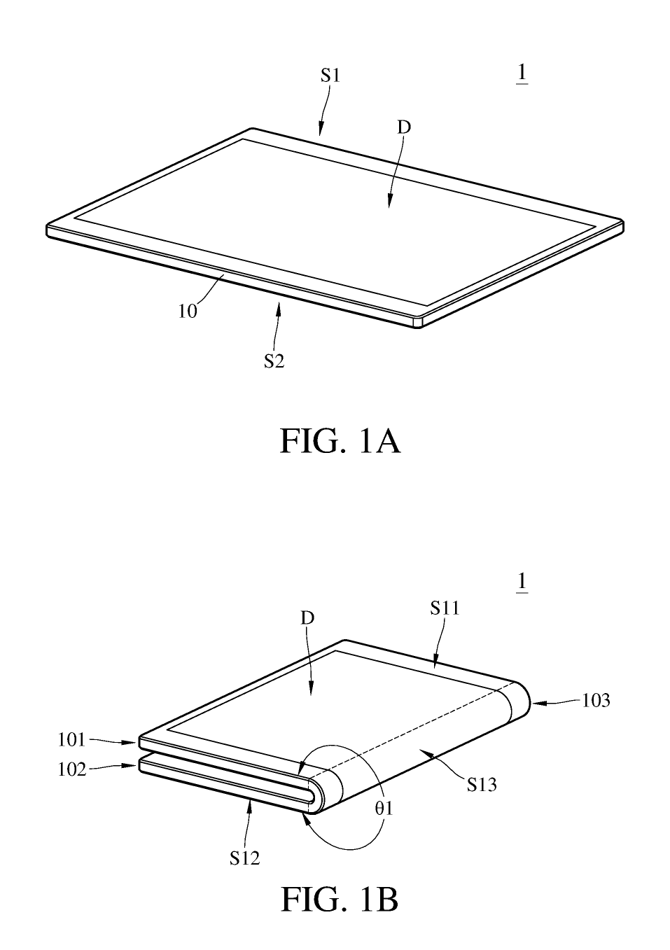

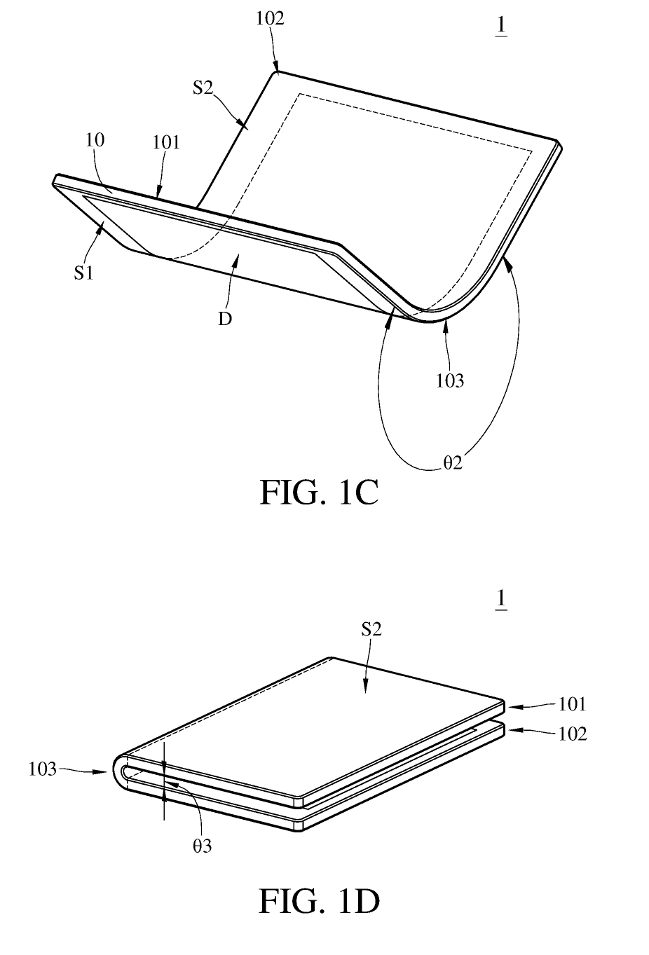

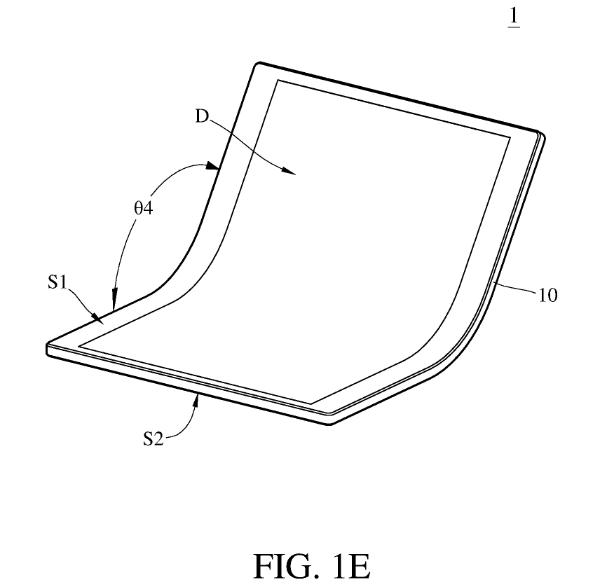

Please refer to FIG. 1A to FIG. 1E. FIG. 1A is a schematic view of a display apparatus that is flattened according to an embodiment of the present disclosure, FIG. 1B is a schematic view of a display apparatus fully outward-folded according to an embodiment of the present disclosure, FIG. 1C is a schematic view of a display apparatus partially outward-folded according to an embodiment of the present disclosure, FIG. 1D is a schematic view of a display apparatus fully inward-folded according to an embodiment of the present disclosure, and FIG. 1E is a schematic view of a display apparatus partially inward-folded according to an embodiment of the present disclosure.

As shown in FIG. 1A, a display apparatus 1 includes a main body 10. The main body 10 has a first surface S1 and a second surface S2 opposite to the first surface S1. The first surface S1 includes a display region D. The display apparatus 1 provides a screen in the display region D. The display apparatus 1 is not limited to a portable electronic device, such as a mobile phone, e-reader or tablet computer.

In an embodiment, the display apparatus 1 is formed by, for example, one or more flexible materials and one or more flexible panels so that the display apparatus 1 can be curved, folded or bended. FIG. 1B to FIG. 1E exemplarily illustrate that the display apparatus 1 is curved differently.

FIG. 1B exemplarily illustrates the display apparatus 1 that is fully outward-folded. Here, outward-folding means that the first surface S1 of the display apparatus 1 is curved and faces the outside. Specifically, the main body 10 is defined to have a first portion 101, a second portion 102 and a curved portion 103. The curved portion 103 is located between and joined to the first portion 101 and the second portion 102. According to the relative position of the first portion 101, the second portion 102 and the curved portion 103, the first surface S1 is defined to have a first sub surface S11, a second sub surface S12 and a curved sub surface S13. The first sub surface S11 is located at the first portion 101, the second sub surface S12 is located at the second portion 102, and the curved sub surface S13 is located at the curved portion 103. The curved portion 103 is formed as the display apparatus 1 is curved by a force. Because of the curved portion 103, the first portion 101 and the second portion 102 are close to each other. In other words, the first sub surface S11 at the first portion 101 is close to the second sub surface S12 at the second portion 102.

In another aspect, the first portion 101 and the second portion 102 have an angle of bending θ1 therebetween. When the display apparatus 1 is fully outward-folded, the angle of bending θ1 is close to 360 degrees. That is, the first portion 101 is almost parallel to the second portion 102. In an embodiment, when the display apparatus 1 is fully outward-folded, the angle of bending θ1 is substantially equal to 360 degrees. FIG. 1C exemplarily illustrates that the display apparatus 1 is partially outward-folded. The angle of bending θ2 in FIG. 1C is smaller than the angle of bending θ1 in FIG. 1B. In other words, the angle of bending is, for example, an included angle between the first surface S1 of the first portion 101 and the first surface S1 of the second portion 102 as the display apparatus 1 is bended. The first sub surface S11, the second sub surface S12 and the curved sub surface S13 can be connected to each other or not; and the related details can be freely defined in reference to the present disclosure by a person of ordinary skill in the art, and the present disclosure does not intend to limit them.

FIG. 1D exemplarily illustrates that the display apparatus 1 is fully inward-folded. Here, inward-folding means that the first surface S1 of the display apparatus 1 is curved and faces the inside. That is, as the display apparatus 1 is bended by a force, the curved portion 103 is formed so that the first sub surface S11 is close to the second sub surface S12. In another aspect, the first portion 101 and the second portion 102 have an angle of bending θ3 therebetween. When the display apparatus 1 is fully inward-folded, the angle of bending θ3 in FIG. 1D is close to 0 degree. That is, the first portion 101 is almost parallel to the second portion 102. In an embodiment, when the display apparatus 1 is fully inward-folded, the angle of bending θ1 is substantially equal to 0 degree. FIG. 1E exemplarily illustrates that the display apparatus 1 is partially inward-folded. The angle of bending θ4 in FIG. 1E is larger than the angle of bending θ3 in FIG. 1D.

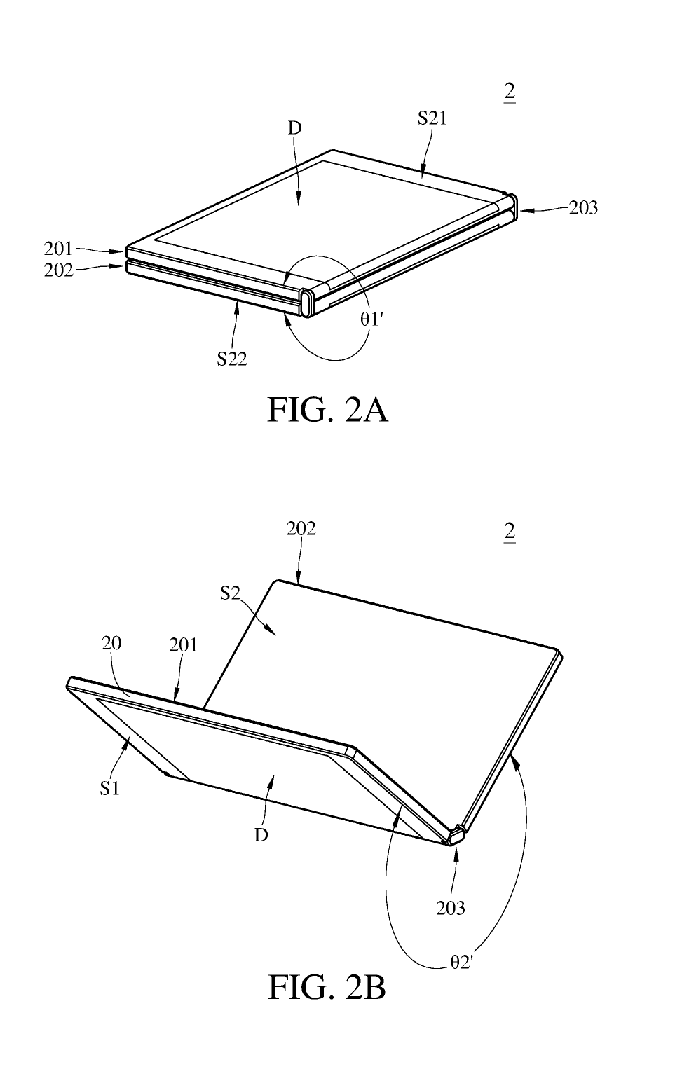

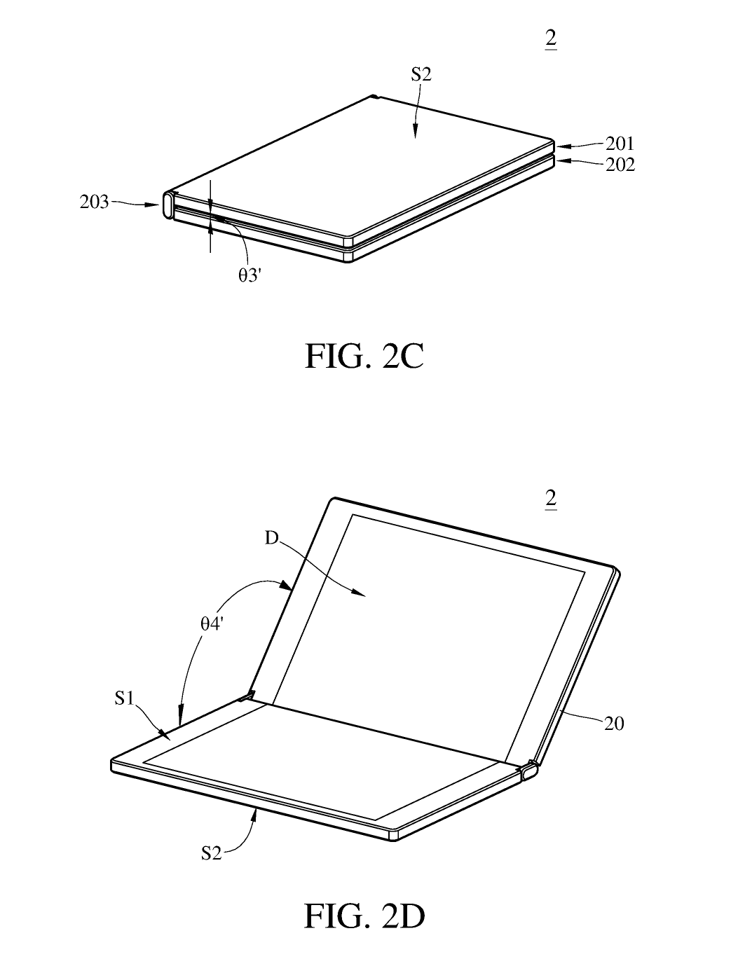

On the other hand, the display apparatus includes a pivot structure and thus, can be folded in an example, as shown in FIG. 2A to FIG. 2D. FIG. 2A is a schematic view of a display apparatus fully outward-folded according to another embodiment of the present disclosure, FIG. 2B is a schematic view of a display apparatus partially outward-folded according to another embodiment of the present disclosure, FIG. 2C is a schematic view of a display apparatus fully inward-folded according to another embodiment of the present disclosure, and FIG. 2D is a schematic view of a display apparatus partially inward-folded according to another embodiment of the present disclosure. A display apparatus 2, as shown in FIG. 2A to FIG. 2D, is similar to the display apparatus 1, as shown in FIG. 1B to FIG. 1E. Unlike the display apparatus 1, a main body 20 of the display apparatus 2 includes a pivot structure 203 that is used for connected to a first portion 201 and a second portion 202 of the display apparatus 20. The first portion 201 is rotatable in relative to the second portion 202 via the pivot structure 203. The definitions of various folding patterns can be referred to the above description and thus, will not be described again hereafter. The following description is based on the embodiment of FIG. 1A to FIG. 1E, and however, a person of ordinary skill in the art should understand with reference to the present disclosure that the embodiment of FIG. 2A to FIG. 2D can be applied to the following description.

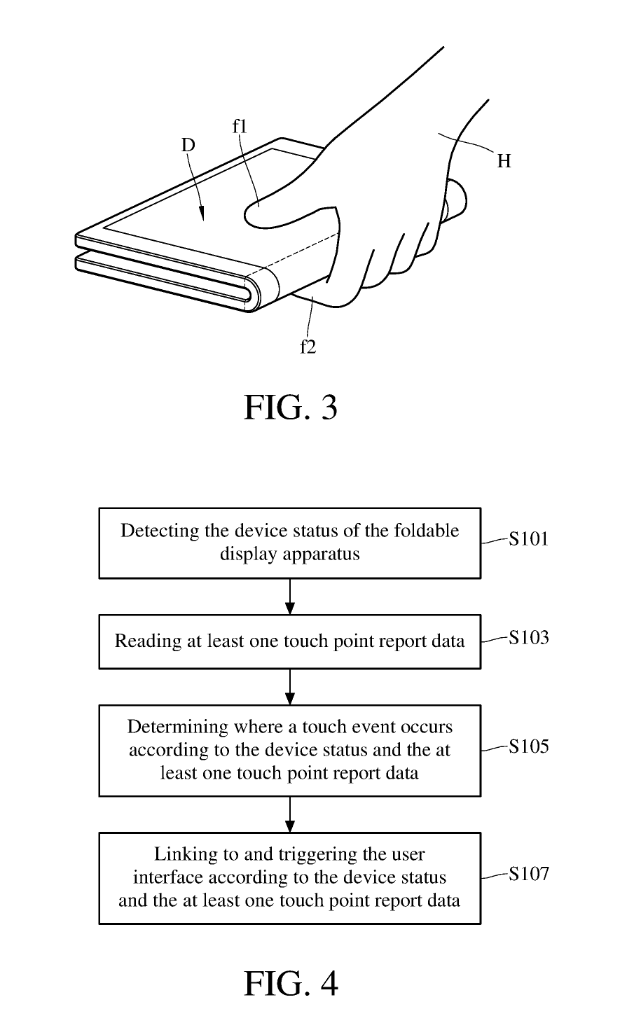

Then, please refer to FIG. 3. FIG. 3 is a schematic view of incorrect operation occurring on the display apparatus that is fully outward-folded according to an embodiment of the present disclosure. FIG. 3 exemplarily illustrates that a user's hand H to hold the display apparatus 1 that is fully outward-folded. In this case, the user's finger f1 touches the first sub surface S11 and is used for controlling the display apparatus 1 by a touch control manner while the user's fingers f2 touch the second sub surface S12 and is used for supporting the display apparatus 1 in the hand H. It was impossible for the display apparatus 1 in the past to recognize the behavior pattern of a user, so the display apparatus 1 might be incorrectly controlled according to the fingers f2 if the display apparatus 1 in the past simultaneously detects the touch types of the finger f1 and the fingers f2 on the first surface S1. Further, the display apparatus 1 would incorrectly operate according to the touch type of the partial palm on the first sub surface S11, the second sub surface S12 or the curved sub surface S13. In a more intuitive definition method, a surface of the display apparatus, which the user watches, is defined as the front of the display apparatus, a surface of the display apparatus, which is opposite to the front of the display apparatus, is defined as the back of the display apparatus, and a curved surface of the display apparatus, which is connected to and located between the front and back of the display apparatus, is defined as the side of the display apparatus. In FIG. 3, the first sub surface S11 is defined as the front of the display apparatus, the second sub surface S12 is defined as the back of the display apparatus, and the curved sub surface S13 is defined as the side of the display apparatus. In other words, when the user needs to hold the display apparatus by touching the back having a display region, an incorrect operation accordingly occurs to the display apparatus.

The following is to explain how the present disclosure overcomes such a predicament by a method for a user interface of a foldable display apparatus, as shown in FIG. 4. FIG. 4 is a flowchart of a method for a user interface of a foldable display apparatus according to an embodiment of the present disclosure. Step S101 is detecting the device status of the foldable display apparatus. Step S103 is reading a plurality of touch point report data. Step S105 is determining a region, in which a touch event occurs, according to the device status and the touch point report data. Step S107 is linking to and triggering the user interface according to the device status and the touch point report data.

In practice, detecting the device status of the foldable display apparatus is done by a device status detector. The device statuses include an inward-folding pattern of a variety of included angles, an outward-folding pattern of a variety of included angles, a flattening pattern, and the orientation of the display apparatus. The device status detector is, for example, a folding detector, two or more gyroscopes, an optical detector, a magnetic field detector, a mechanical detector, a pressure detector, or a combination thereof, which is used to detect the status of the display apparatus.

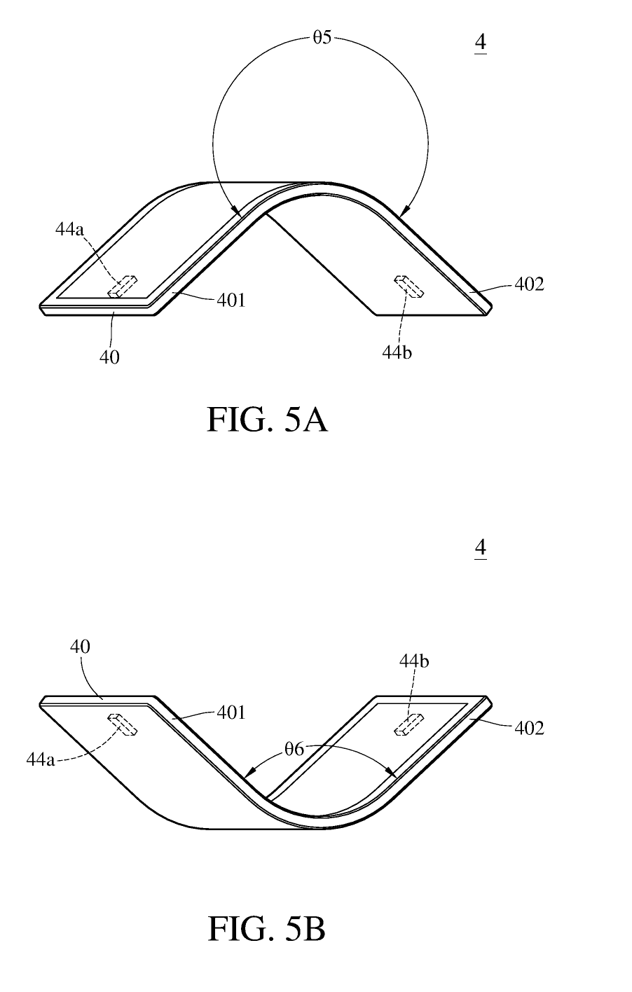

Please refer to FIG. 5A and FIG. 5B. FIG. 5A is a schematic view of a display apparatus according to yet another embodiment of the present disclosure, and FIG. 5B is a schematic view of a display apparatus according to yet another embodiment of the present disclosure. In the embodiment, as shown in FIG. 5A, a display apparatus 4 further includes an accelerometer 44a and an accelerometer 44b. The accelerometer 44a is located at a first portion 401 of a main body 40, and the accelerometer 44b is located at a second portion 402 of the main body 40. In the method for the user interface of the foldable display apparatus in the present disclosure, the determination of whether the display apparatus 4 is now flattened, fully outward-folded, partially outward-folded, fully inward-folded, or partially inward-folded, is made according to the detection information of the accelerometer 44a or the accelerometer 44b in an example, in order to control the display apparatus 4 according to the determination. The following description is based on a case that the display apparatus uses an accelerometer to detect its device status, and however, the disclosure is not limited to this case. As described above, the display apparatus 4 is able to be disposed with a folding detector, two or more gyroscopes, an optical detector, a magnetic field detector, a mechanical detector, a pressure detector, or a combination thereof, in order to detect its status.

For the embodiment shown in FIG. 5A and FIG. 5B, the detection information of the accelerometer 44a or the accelerometer 44b in an example is used for determining the angle of bending θ5 and the angle of bending θ6, and then the current status of the display apparatus 4 can be determined according to these angle of bending. In an embodiment, when the angle of bending is not larger than 45 degrees, the display apparatus is determined as being fully inward-folded; when the angle of bending is larger than 45 degrees but not larger than 135 degrees, the display apparatus is determined as being partially inward-folded; when the angle of bending is larger than 135 degrees but not larger than 180 degrees, the display apparatus is determined as flattening pattern; when the angle of bending is larger than 180 degrees but not larger than 300 degrees, the display apparatus is determined as being partially outward-folded; and when the angle of bending is larger than 300 degrees but not larger than 360 degrees, the display apparatus is determined as being fully outward-folded.

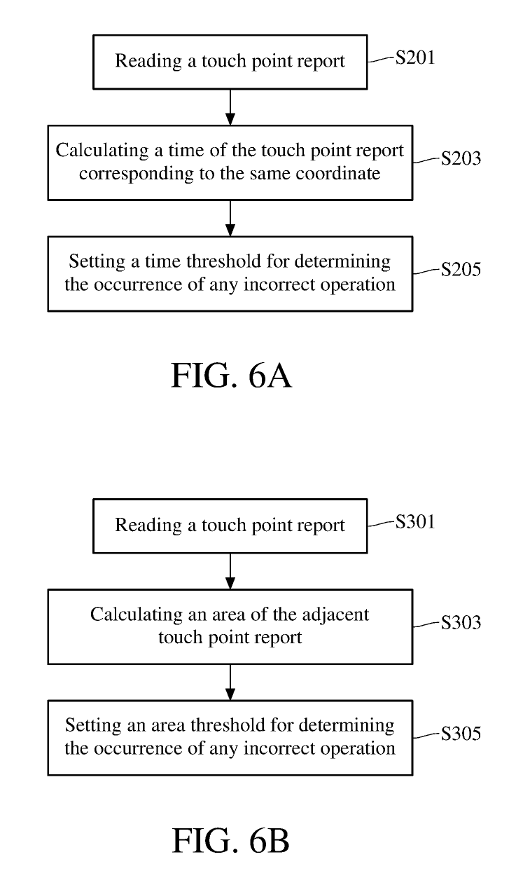

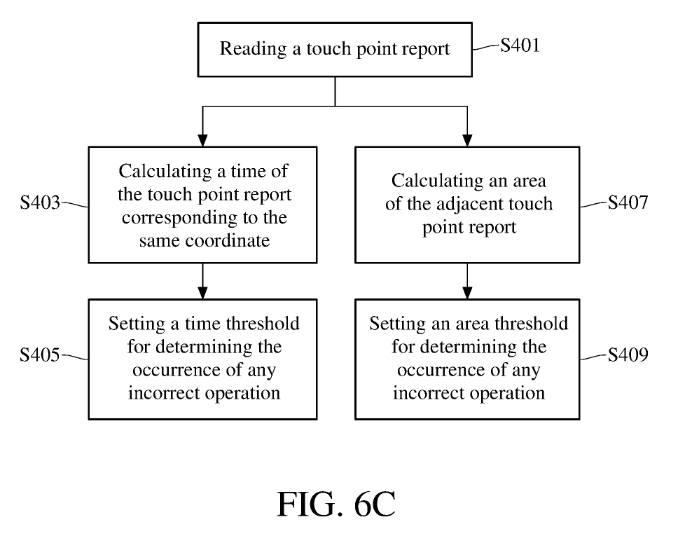

Please further refer to FIG. 6A, FIG. 6B and FIG. 6C to explain other detailed determination processes in the method for the user interface of the foldable display apparatus in the present disclosure. FIG. 6A is flowchart of determining a touch point report according to an embodiment of the present disclosure, FIG. 6B is flowchart of determining a touch point report according to an embodiment of the present disclosure, and FIG. 6C is flowchart of determining a touch point report according to an embodiment of the present disclosure.

In the embodiment, as shown in FIG. 6A, step S201 is reading a touch point report. Step S203 is calculating a time of the touch point report corresponding to the same coordinate. Step S205 is determining the occurrence of any incorrect operation according to a time threshold, that is, determining whether the touch point report data is a valid touch event. Here, a touch point report is, for example, a related action that the display panel or the integrated circuit of touch control provides the information of one or more touch points, such as coordinate or intensity, after the display panel of the display apparatus 1 senses the one or more touch points. As shown in FIG. 6B, step S301 is reading a touch point report. Step S303 is calculating an area of adjacent touch point report. Step S305 is determining the occurrence of any incorrect operation according to an area threshold, that is, determining whether the touch point report data is a valid touch event. In the embodiment, as shown in FIG. 6C, step S401 is reading a touch point report. Step S403 is calculating a time of the touch point report corresponding to the same coordinate. Step S405 is determining the occurrence of any incorrect operation according to a time threshold, that is, determining whether the touch point report data is a valid touch event. Step S407 is calculating an area of the adjacent touch point report. Step S409 is determining the occurrence of any incorrect operation according to an area threshold, that is, determining whether the touch point report data is a valid touch event. In other words, the determination of the time of the touch point report and the determination of the area of the adjacent touch point report are performed at the same time in the embodiment illustrated in FIG. 6C

More particularly, in the method, which region of the display apparatus a touch occurs in, such as the front, back or side of the display apparatus, decides whether the touch point report data is a valid touch event, and then the display apparatus is controlled according to the information of the touch. The definitions of the front, back and side of the display apparatus can be referred to the above description, and they will not described again here. Moreover, valid touch events include a touch event, a click/sliding event, a long-click event, etc.

In an embodiment, when the device status is the outward-folding pattern and the touch point report data occurs in the side or back, determining where a touch event occurs, according to the device status and the touch point report data further includes comparing the time of a continuous touch with a first time threshold, e.g. a time period of 0.5˜10 seconds. When the time is smaller than the first time threshold, a touch event is conformed. Alternately, when the touch point report data occurs in the front, the time of a continuous touch is further compared with a second time threshold, e.g. a time period of 0.5˜10 seconds. When the time of the continuous touch is larger than the second time threshold, the continuous touch is determined as a long-click event. When the time of the continuous touch is smaller than the second time threshold, the continuous touch is determined as a clicking or sliding event.

In another embodiment, when the device status is the flattening pattern, determining where the touch event occurs, according to the device status and the touch point report data further includes comparing the time of a continuous touch with a third time threshold, e.g. a period of 0.5˜10 seconds. When the time of the continuous touch is larger than the third time threshold, the continuous touch is determined as a long-click event. When the time of the continuous touch is smaller than the third time threshold, the continuous touch is determined as a clicking or sliding event.

In yet another embodiment, when the device status is the outward-folding pattern and the touch point report data occurs in the side or back, determining where a touch event occurs, according to the device status and the touch point report data, further includes comparing the area of a continuous touch with a first area threshold. When the area of the continuous touch is smaller than the first area threshold, the continuous touch is determined as a touch event. Alternately, when the touch point report data occurs in the front region, the area of a continuous touch is compared with a second area threshold. When the area of the continuous touch is larger than the second area threshold, the continuous touch is determined as a long-click event. When the area of the continuous touch is smaller than the second area threshold, the continuous touch is determined as a clicking or sliding event.

In yet another embodiment, when the device status is the flattening pattern, determining where a touch event occurs, according to the device status and the touch point report data further includes comparing an area of a continuous touch with a third area threshold. When the area of the continuous touch is larger than the third area threshold, the continuous touch is determined as a long-click event. When the area of the continuous touch is smaller than the third area threshold, the continuous touch is determined as a clicking or sliding event.

In yet another embodiment, when the device status is a curved type and the touch point report data occurs on an edge or in the back region, the step of determining where the touch event occurs, according to the device status and the touch point report data further includes comparing an area of a continuous touch with a first area threshold. When an area of a continuous touch is smaller than the first area threshold, this continuous touch is determined as a touch event. When the touch point report data occurs in the front region, comparing the area of a continuous touch with a second area threshold is further performed. When the area of the continuous touch is larger than the second area threshold, this continuous touch is determined as a holding event. When the area is smaller than the second area threshold, this continuous touch is determined as a clicking event or a sliding event.

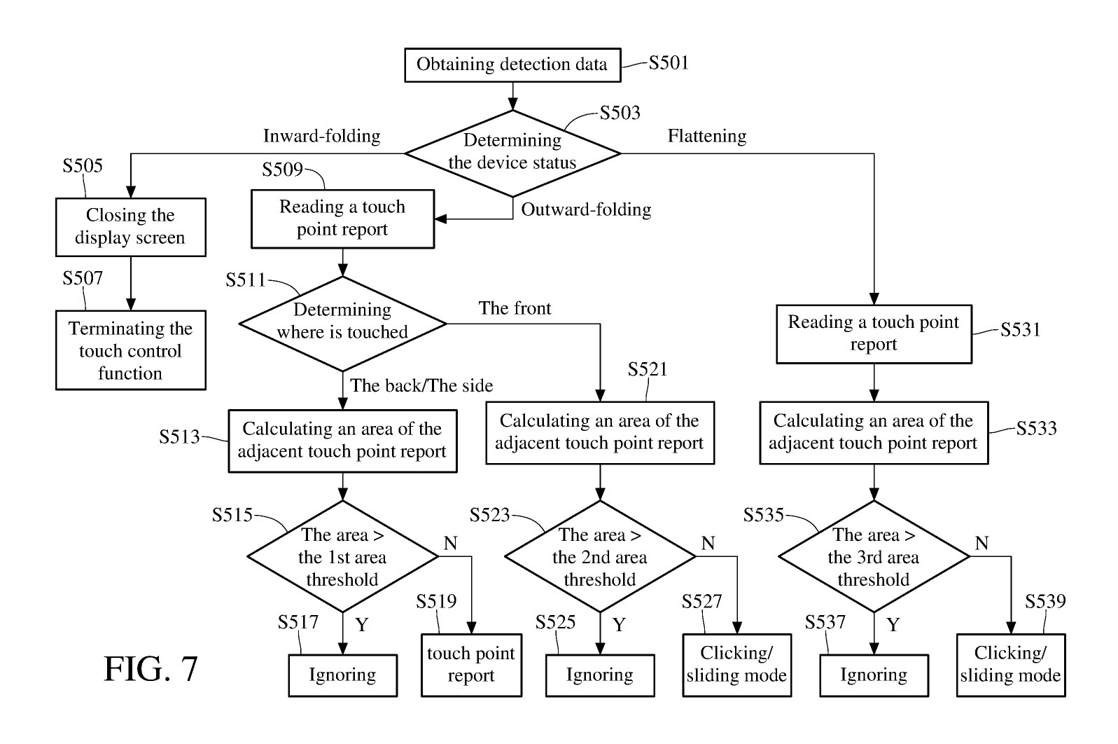

Please further refer to FIG. 7 for an exemplary description. FIG. 7 is a detailed flowchart of a method for a user interface of a foldable display apparatus according to an embodiment of the present disclosure. In the embodiment, as shown in FIG. 7, the related steps are described below.

In step S501, obtain detection data from the device status detector.

In step S503, determine the device status according to the obtained detection data.

When the device status is determined as an inward-folding pattern in step S503, the process proceeds to step S505 for directly turning off the display screen, and then proceeds to step S507 for terminating the touch control function. When the device status is determined as an outward-folding pattern in step S503, the process proceeds to step S509 for reading a touch point report.

In step S511, determine if the location of the touch point report is in the front, back, or side.

When it is determined that the location of the touch point report is in the back or side in step S511, the process proceeds to step S513 for calculating an area of the adjacent touch point report. That is, determining an area constituted by adjacent ones of a number of touch points.

In step S515, determine whether the area is larger than a first area threshold.

When the area is larger than the first area threshold in step S515, this result indicates that the user may touch the back or side to hold or support the display apparatus by the fingers or palm. Then, the process proceeds to step S517 for not reacting to the current touch points, that is, not controlling the display apparatus according to these touch points. In other words, these current touch points are determined as an invalid touch event.

When it is determined in step S515 that the area is not larger than the first area threshold, this result indicates that the user is really performing touch input. In other words, the current touch points are determined as a valid touch event. Then, the process proceeds to step S519 for reporting these touch points and performing the following process and control.

When it is determined in step S511 that the touch point is located in the front, the process proceeds to step S521 for calculating an area of adjacent touches.

Then, in step S523, determine whether the area is larger than a second area threshold.

When it is determined in step S523 that the area is larger than the second area threshold, this result indicates that the user is touching the front of the display apparatus by the finger, or touching the front of the display apparatus to hold or support the display apparatus by the palm. Accordingly, the process proceeds to step S525 for not reacting to the current touch points, i.e. not controlling the display apparatus according to these touch points. In other words, these touch points are determined as an invalid touch event.

When it is determined in step S523 that the area is not larger than the second area threshold, this result indicates that the user is really performing touch input. Accordingly, the process proceeds to step S527 for reporting the touch points at this time and further processing the report for a control, such as entering into the clicking mode or sliding mode. In other words, these touch points are determined as a valid touch event.

When it is determined that the device status is the flattening pattern in step S503, the process proceeds to step S531 for reading a touch point report.

In step S533, calculate the area of adjacent touch points.

In step S535, determine whether the area of adjacent touch points is larger than a third area threshold.

When it is determined in step S535 that the area of adjacent touch points is larger than the third area threshold, this result indicates that the user is touching the front of the display apparatus by the finger or the palm in order to hold or support the display apparatus. Accordingly, the process proceeds to step S537 for ignoring these touch points at this time, that is, not controlling the display apparatus in response to these touch points. In other words, these touch points at this time are determined as an invalid touch event.

When it is determined in step S535 that the area of adjacent touch points is not larger than the third area threshold, this result indicates that the user is really performing touch input. Accordingly, the process proceeds to step S539 for reporting these touch points and performing the following process and control. In other words, these touch points at this time are determined as a valid touch event.

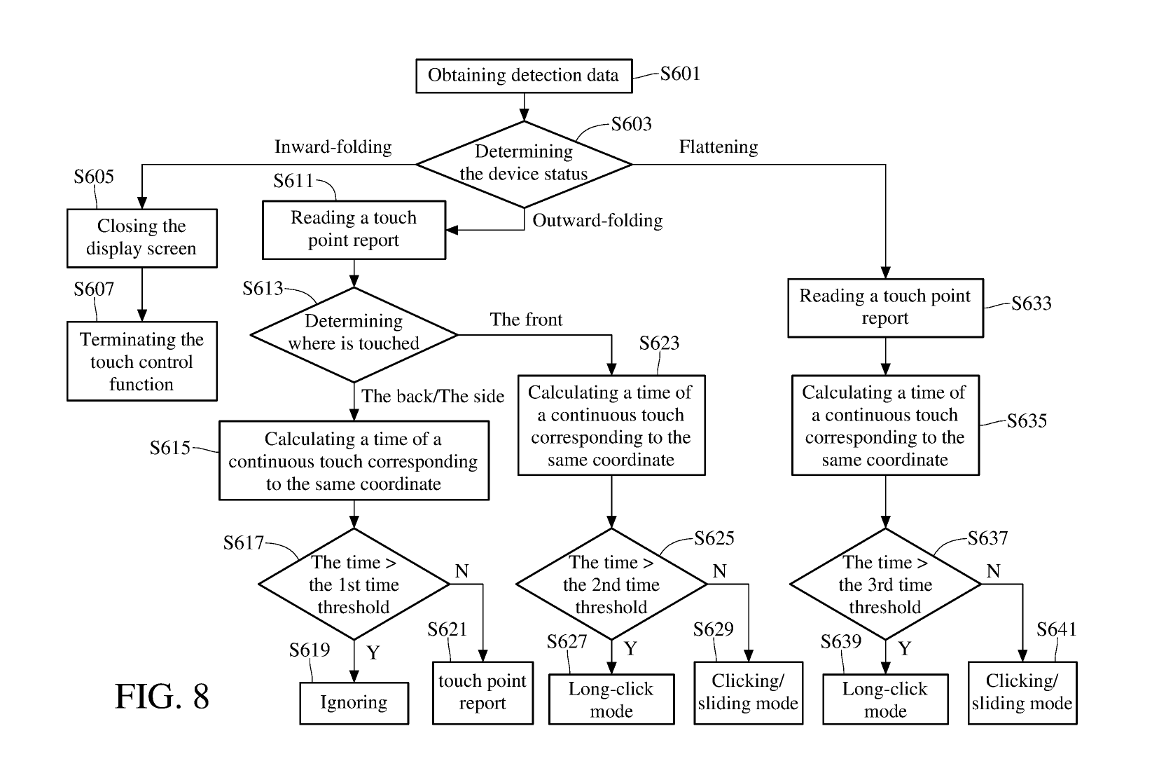

Further refer to FIG. 8 for an exemplary description. FIG. 8 is a detailed flowchart of a method for a user interface of a foldable display apparatus according to another embodiment of the present disclosure.

In step S601, obtain the detection data of the device status detector.

In step S603, determine the device status according to the obtained detection data.

When it is determined that the device status is the inward-folding pattern, the process proceeds to step S605 for directly closing the display screen, and then proceeds to step S607 for terminating the touch control function.

When it is determined that the device status is the outward-folding pattern, the process proceeds to step S611 for reading a touch point report.

In step S613, determine if the touch points are located in the front, back, or side of the display apparatus.

When it is determined in step S613 that the touch points are located in the back or side of the display apparatus, the process proceeds to step S615 for calculating the time of a continuous touch corresponding to the same coordinate.

In step S617, determine whether the time of the continuous touch corresponding to the same coordinate is larger than a first area threshold.

When it is determined in step S617 that the time of the continuous touch corresponding to the same coordinate is larger than the first time threshold, this result indicates that the user is holding or supporting the display apparatus. Accordingly, the process proceeds to step S619 for ignoring these touch points, that is, not controlling the display apparatus in response to these touch points. In other words, these touch points at this time are determined as an invalid touch event.

Alternately, when it is determined that the time of the continuous touch corresponding to the same coordinate is not larger than the first time threshold, this result indicates that the user is performing touch input. Accordingly, the process proceeds to step S621 for reporting the touch points at this time and further processing the report for a control. In other words, these touch points at this time are determined as a valid touch event.

When it is determined in step S613 that the touch points are located in the front of the display apparatus, the process proceeds to step S623 for calculating the time of a continuous touch corresponding to the same coordinate.

Then, in step S625, determine whether the time of the continuous touch corresponding to the same coordinate is larger than a second time threshold.

When it is determined in step S625 that the time of the continuous touch corresponding to the same coordinate is larger than the second time threshold, this result indicates that the user is doing a long-click onto the front of the display apparatus. Accordingly, the process proceeds to step S627 for controlling the display apparatus according to a command corresponding to the long-click. In other words, these touch points at this time are determined as a valid touch event.

When it is determined in step S625 that the time of the continuous touch corresponding to the same coordinate is not larger than the second time threshold, this result indicates that the user is really sliding the finger(s) on or clicking the display apparatus. Accordingly, the process proceeds to step S629 for reporting the touch points at this time and further processing the report for a control. In other words, the touch points at this time are determined as a valid touch event.

When it is conformed in step S603 that the device status is the flattening pattern, the process proceeds to step S633 for reading touch point reports.

In step S635, calculate the time of a continuous touch corresponding to the same coordinate.

Then, in step S637, determine whether the time of a continuous touch corresponding to the same coordinate is larger than a third time threshold.

When it is conformed in step S637 that the time of the continuous touch corresponding to the same coordinate is larger than the third time threshold, this result indicates that the user is doing a long-click onto the front of the display apparatus. Accordingly, the process proceeds to step S639 for controlling the display apparatus according to a command corresponding to the long-click. In other words, the touch points at this time are determined as a valid touch event.

When it is determined in step S637 that the time of a continuous touch corresponding to the same coordinate is not larger than the second time threshold, thus result indicates that the user is really sliding the finger(s) on or clicking the display apparatus. Accordingly, the process proceeds to step S641 for reporting the touch points at this time and further processing the report for a control. In other words, the touch points at this time are determined as a valid touch event.

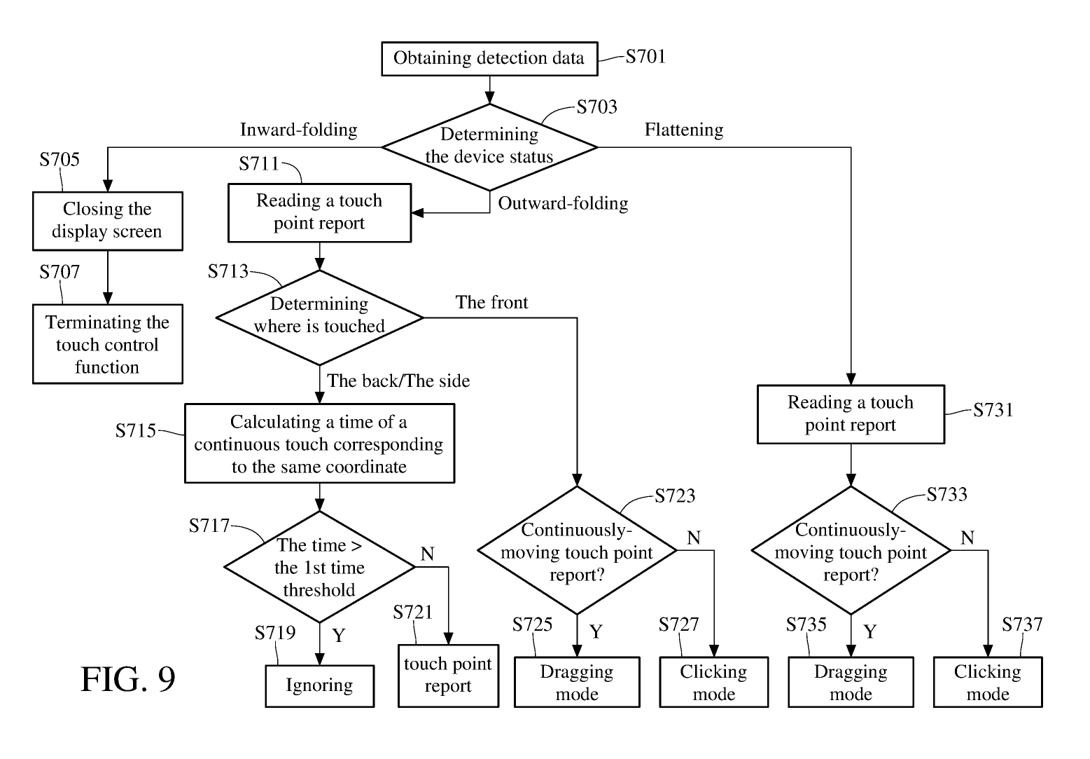

Please further refer to FIG. 9 for an exemplary explanation. FIG. 9 is a detailed flowchart of a method for a user interface of a foldable display apparatus according to yet another embodiment of the present disclosure.

In step S701, obtain the detection data of the device status detector.

In step S703, determine the device status according to the obtained detection data.

When it is determined that the device status is the inward-folding pattern, the process proceeds to step S705 for directly closing the display screen, and then proceeds to step S707 for terminating the touch control function.

Alternately, when it is determined that the device status is the outward-folding pattern, the process proceeds to step S711 for reading a touch point report.

In step S713, determine if the touch points are located in the front, back or side of the display apparatus.

When it is determined in step S713 that the touch point are located in the back or side of the display apparatus, the process proceeds to step S715 for calculating the time of a continuous touch corresponding to the same coordinate.

In step S717, determine whether the time of the continuous touch corresponding to the same coordinate is larger than a first area threshold.

When it is determined in step S717 that the time of the continuous touch corresponding to the same coordinate is larger than the first time threshold, this result indicates that the user is holding or supporting the display apparatus. Accordingly, the process proceeds to step S719 for ignoring these touch points at this time, that is, not controlling the display apparatus in response to these touch points. In other words, these touch points at this time are determined as an invalid touch event.

When it is determined that the time of a continuous touch corresponding to the same coordinate is not larger than the first time threshold, this result indicates that the user is really operating the display apparatus by a drag manner. Accordingly, the process proceeds to step S721 for controlling the display apparatus according to a command corresponding to the drag. In other words, the touch points at this time are determined as a valid touch event.

When it is determined in step S713 that the touch point is located in the front of the apparatus, the process proceeds to step S723 for determine whether the touch point continuously moves.

When it is determined in step S723 that the touch point continuously moves, the process proceeds to step S725 for controlling the display apparatus in the dragging mode. In other words, the touch points at this time are determined as a valid touch event.

When it is determined in step S723 that the touch point does not move continuously, the process proceeds to step S727 for controlling the display apparatus in the clicking mode. In other words, the touch points at this time are determined as a valid touch event.

When it is determined in step S703 that the device status is the flattening pattern, the process proceeds to step S731 for reading one or more touch points.

Then, in step S733, determine whether the one or more touch points move continuously.

When it is determined in step S733 that the one or more touch points move continuously, the display apparatus is controlled in the dragging mode in step S735. In other words, the touch points at this time are determined as a valid touch event.

When it is determined in step S733 that the one or more touch points do not move continuously, the process proceeds to step S737 for controlling the display apparatus in the clicking mode. In other words, the touch points at this time are determined as a valid touch event.

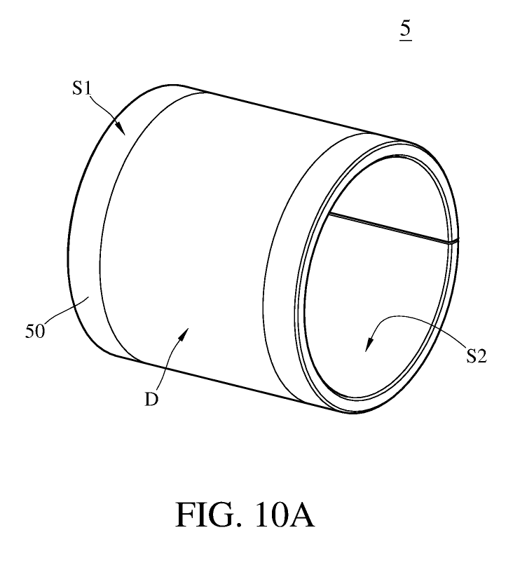

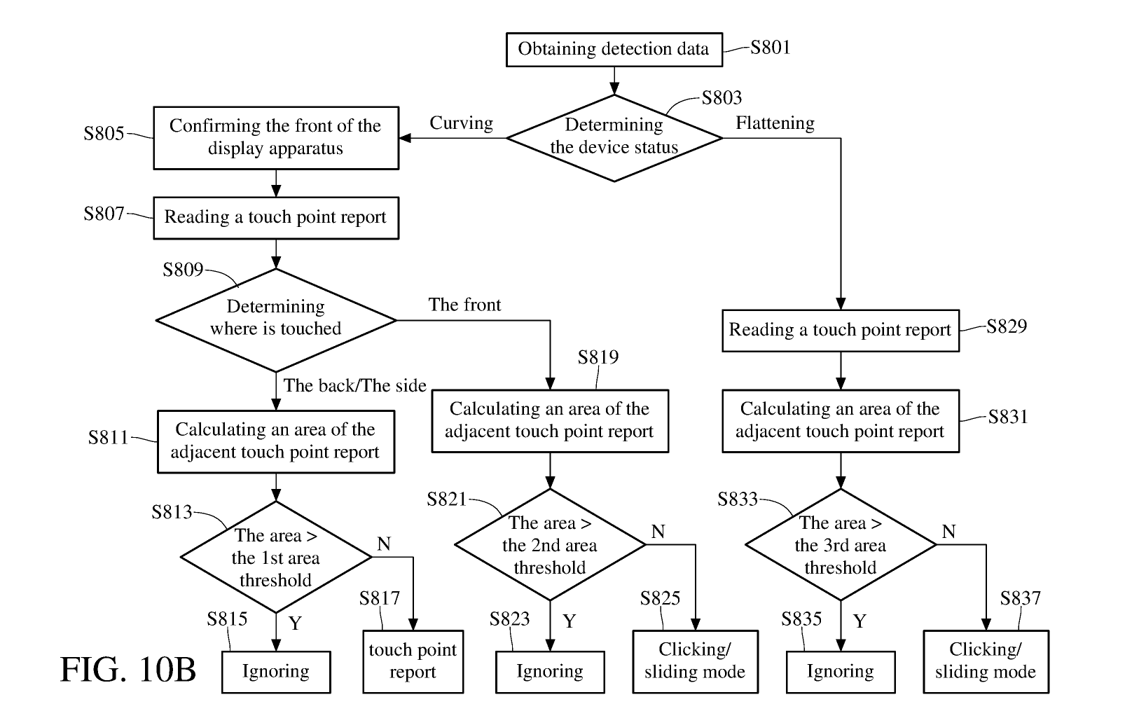

Please further refer to FIG. 10A for illustrating another implementation. FIG. 10A is a schematic view of a foldable display apparatus that is curved as a circle according to an embodiment of the present disclosure. In the embodiment of FIG. 10A, a display apparatus 5 is curved as a circle that can be a closed circle or an open circle. As shown in FIG. 10A, the display region D of the display apparatus 5 faces outside and can be seen by the user. In the figure, a first surface S1 of the display apparatus 5 is defined as the front or back of the display apparatus 5 according to whether the first surface S1 faces or is away from the user. That is, the user's attention defines a region of the first surface S1 as the front or back of the display apparatus 5. Therefore, the display apparatus 5 can use the following method for a user interface to avoid the occurrence of any incorrect operation. Please further refer to FIG. 10B for an exemplary explanation. FIG. 10B is a detailed flowchart of a method for a user interface of a foldable display apparatus according to yet another embodiment of the present disclosure.

In step S801, obtain the detection data of the device status detector.

In step S803, determine, according to the obtained detection data, whether or not the device status is the flattening pattern.

When it is determined in step S803 that the device status is not the flattening pattern, the process proceeds to step S805 for defining the front of the display apparatus.

Then, in step S807, reading a touch point report.

In step S809, determine if the touch points are located in the front, back or side of the display apparatus.

When it is determined in step S809 that the touch points are located in the back or side of the display apparatus, the process proceeds to step S811 for calculating the area of the adjacent touch point report.

In step S813, determining whether the area of the adjacent touch point report is larger than a first area threshold.

When it is determined in step S813 that the area of the adjacent touch point report is larger than the first area threshold, this result indicates that the user is holding or supporting the display apparatus. Accordingly, the process proceeds to step S815 for ignoring the touch points at this time, that is, not controlling the display apparatus in response to the touch points at this time. In other words, these touch points at this time are determined as an invalid touch event.

When it is determined in step S813 that the area of the adjacent touch point report is not larger than the first area threshold, this result indicates that the user is really performing a touch input. Accordingly, the process proceeds to step S817 for reporting the touch points at this time and further processing the report for a control. In other words, the touch points at this time are determined as a valid touch event.

When it is determined in step S809 that the touch points are located in the front of the display apparatus, the process proceeds to step S819 for calculating the area of the adjacent touch point report.

In step S821, determine whether the area of the adjacent touch point report is larger than a second area threshold.

When it is determined in step S821 that the area of the adjacent touch point report is larger than the second area threshold, this result indicates that the user is holding or supporting the display apparatus. Accordingly, the process proceeds to step S823 for ignoring these touch points at this time. That is, the display apparatus is not controlled in response to these touch points. In other words, these touch points at this time are determined as an invalid touch event.

When it is conformed in step S821 that the area of the adjacent touch point report is not larger than the second area threshold, the process proceeds to step S825 for controlling the display apparatus by the clicking mode or the sliding mode. In other words, the touch points at this time are determined as a valid touch event.

When it is determined in step S803 that the device status is the flattening pattern, the process proceeds to step S829 for reading a touch point report.

Then, in step S831, calculate the area of the adjacent touch point report.

In step S833, determine whether the area of the adjacent touch point report is larger than a third area threshold.

When it is determined in step S833 that the area of the adjacent touch point report is larger than the third area threshold, the process proceeds to step S835 for ignoring these touch points at this time. That is, the display apparatus is not controlled in response to these touch points. In other words, these touch points at this time are determined as an invalid touch event.

When it is determined in step S833 that the area of the adjacent touch point report is not larger than the third area threshold, the process proceeds to step S837 for controlling the display apparatus in the clicking mode or the sliding mode. In other words, the touch points at this time are determined as a valid touch event.

In an embodiment, when the touch point report data occur in the back of the display apparatus and are determined as a touch event, coordinates of the touch points in the back of the display apparatus are able to be mapped to coordinates of the front of the display apparatus by the following method:

A) if the folding axis is substantially vertical to the X direction at X=Xm, a coordinate transform equation:

X′=Xm*2−X;

Y′=Y.

B) if the folding axis is substantially vertical to the Y direction at Y=Ym, a coordinate transform equation:

X′=X;

Y′=Ym*2−Y.

The above X and Y are primary coordinates, and the above X′ and Y′ are transformed coordinates.

In an embodiment, when the touch point report data occurs in the back of the display apparatus and is determined as a touch event, a clicking or sliding event occurring in the back of the display apparatus is able to link to and trigger the user interface. For example, such an event is able to trigger an operation of the display apparatus, such as controlling a camera shutter, playing or pausing or stopping music or a video, turning to a previous or next page, checking, answering or handing up a phone call, adjusting volume, rolling or zooming in or out a browsing screen, adjusting display brightness, giving a control in a game, etc. These operations are only for an exemplary description, and the disclosure does not intend to limit any available operation.

To sum up, the present disclosure provides a method for a user interface of a foldable display apparatus. In the method, the determination of whether any incorrect operation occurs to the foldable display apparatus in response to a touch is made according to the device status of the foldable display apparatus and the touch point report data. By determining both the folding pattern and the information of touch points, the device status of the foldable display apparatus may be accurately determined as the inward-folding pattern, the outward-folding pattern or the flattening pattern, and accordingly, the information of touch points may be accurately transformed into a control command, or ignored. Therefore, the display apparatus may be prevented from an incorrect operation caused by a touch.

What is claimed is:

1. A method of an user interface of a foldable display apparatus, the method comprising steps of:
detecting a device status of the foldable display apparatus;
reading at least one touch point report data;
determining a region, in which a touch event occurs, according to the device status and the at least one touch point report data; and
triggering the user interface according to the device status and the at least one touch point report data.

2. The method according to claim 1, wherein the step of detecting the device status of the foldable display apparatus is performed by a device status detector, and the device status comprises an inward-folding pattern of an included angle, an outward-folding pattern of an included angle, flattening pattern or a disposition orientation of the foldable display apparatus.

3. The method according to claim 1, wherein the step of determining a region, in which a touch event occurs, according to the device status and the at least one touch point report data further comprises:
determining whether the at least one touch point report data is a valid touch event,
wherein the valid touch event comprises a touch event, click/sliding event or long-click event.

4. The method according to claim 3, wherein the step of determining whether the at least one touch point report data is a valid touch event comprises:
comparing a time of a continuous touch at a coordinate with a first time threshold when the device status is an outward-folding pattern and the at least one touch point report data occurs in an edge or back region of the foldable display apparatus; and
determining that a touch event occurs when the time is less than the first time threshold.

5. The method according to claim 3, wherein the step of determining whether the at least one touch point report data is a valid touch event comprises:
comparing a time of a continuous touch with a second time threshold when the at least one touch point report data occurs in a front region;
determining that the long-click event occurs when the time is larger than the second time threshold; and
determining that the click/sliding event occurs when the time is smaller than the second time threshold.

6. The method according to claim 3, wherein the step of determining whether the at least one touch point report data is a valid touch event comprises:
comparing a time of a continuous touch with a third time threshold when the device status is a flattening pattern;
determining that the long-click event occurs when the time is larger than the third time threshold; and
determining that the click/sliding event occurs when the time is smaller than the third time threshold.

7. The method according to claim 3, wherein the step of determining whether the at least one touch point report data is a valid touch event comprises:
comparing an area of a continuous touch with a first area threshold when the device status is an outward-folding pattern and the at least one touch point report data occurs in an edge or a back region; and
determining that the touch event occurs when the area is smaller than the first area threshold.

8. The method according to claim 3, wherein the step of determining whether the at least one touch point report data is a valid touch event comprises:
comparing an area of a continuous touch with a second area threshold when the at least one touch point report occurs in a front region;
determining that the continuous touch is a long-click event when the area is larger than the second area threshold; and
considering that the click/sliding event occurs, when the area is smaller than the second area threshold.

9. The method according to claim 3, wherein the step of determining whether the at least one touch point report data is a valid touch event comprises:
comparing an area of a continuous touch with a third area threshold when the device status is a flattening pattern;
determining that the continuous touch is a long-click event when the area of the continuous touch is larger than the third area threshold; and
determining that the continuous touch is a clicking or sliding event when the area of the continuous touch is smaller than the third area threshold.

10. The method according to claim 2, wherein the device status detector is a folding detector, an optical detector, a magnetic field detector, a mechanical detector, a pressure detector, or two or more gyroscopes.

11. The method according to claim 3, wherein the step of determining whether the at least one touch point report data is a valid touch event comprises:
comparing an area of a continuous touch with a first area threshold when the device status is a curved type; and
determining that the touch event occurs when the area is smaller than the first area threshold.

12. The method according to claim 3, wherein when the at least one touch point report data occurs in a back region and the determination of the touch event is made, a coordinate of the at least one touch point in the back of the display apparatus is mapped to a coordinate in the front of the display apparatus.

13. The method according to claim 12, wherein mapping the coordinate of the at least one touch point in the back of the display apparatus to the coordinate in the front of the display apparatus comprises:
A) when a folding axis is substantially vertical to a X direction at X=Xm, using a coordinate transform equation expressed as:
X′=Xm*2−X; and
Y′=Y;
B) when the folding axis is substantially vertical to a Y direction at Y=Ym, using a coordinate transform equation expressed as:
X′=X; and
Y′=Ym*2−Y;
wherein X and Y are primary coordinates, and X′ and Y′ are transformed coordinates.

14. The method according to claim 3, wherein when the at least one touch point report data occurs in a back region and the determination of the valid touch event is made, the user interface is linked to and triggered by a clicking or sliding event occurring in the back of the di splay apparatus.

15. The method according to claim 1, wherein operations on the user interface comprise controlling a camera shutter, playing or pausing or stopping music or a video, turning to a previous or next page, checking, answering or hanging up a phone call, volume control, rolling or zooming in or out a browsing screen, brightness adjustment, or giving a control in a game.

16. The method according to claim 4, wherein the first time threshold ranges from 0.5 seconds to 10 seconds.

17. The method according to claim 5, wherein the second time threshold ranges from 0.5 seconds to 10 seconds.

18. The method according to claim 6, wherein the third time threshold ranges from 0.5 seconds to 10 seconds.
